(19) United States
(12) Patent Application Publication
(10) Pub. No.: US 2008/0192684 A1
(43) Pub. Date: Aug. 14, 2008

(54) Access reservation in wireless communications

(75) Inventor: Janne Tervonen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/704,225

(22) Filed: Feb. 9, 2007

(51) Int. Cl. H04Q 7/00

(52) U.S. Cl. 370/329

(57) ABSTRACT

The present invention relates to a method for arranging access reservation between wireless devices. A reservation establishment request is generated for requesting establishment or modification of uni-directional reservation by a second device for transmitting data to a first device, the reservation establishment request comprising an information element indicating reservation type. The reservation establishment request is transmitted to the second device. A reservation for data transmission associated with the first device is controlled on the basis of the information element.

### FIELD OF THE INVENTION

The present invention relates to arranging access reservation in wireless communications.

### BACKGROUND OF THE INVENTION

Various technologies have been developed for local area wireless communications. IEEE 802.11 based technologies and Bluetooth technologies are some examples of wireless local area networks. Ultra wideband (UWB) is an example of a technology providing even higher data rates.

WiMedia Alliance has developed specifications to standardize multi-vendor UWB inter-operability. The WiMedia Ultra-Wideband (UWB) Common Radio Platform incorporates media access control (MAC) layer and physical (PHY) layer specifications based on Multi-band Orthogonal Frequency Division Multiplexing (MB-OFDM).

The architecture of the WiMedia MAC service is fully distributed. All devices provide all required MAC functions and optional functions as determined by the application. There is no device acting as a central coordinator. Coordination of devices within radio range is achieved by the exchange of beacon frames. Periodic beacon transmission enables device discovery, supports dynamic network organization, and provides support for mobility. Beacons provide the basic timing for the network and carry reservation and scheduling information for accessing the medium. Distributed Reservation Protocol (DRP) is used to reserve certain amount of bandwidth for a given data transmission for a client. DRP reservations are unidirectional: that is, only a device that establishes the reservation (owner of the DRP reservation) is authorized to send data, and only the transmitter device can establish a new DRP reservation.

WiNet is a WiMedia working group defining IP connectivity support for WiMedia UWB radio platform. WiNet defines a basic set of required functionality to enable IP traffic on top of UWB radio. Architecturally, WiNet resides directly on top of the WiMedia MAC layer.

By definition, WiNet (client) devices are not allowed to forward frames they received from another WiNet device. However, a WiNet bridge is a device capable of forwarding frames between WiNet devices and/or different network technologies. A WiNet client may request a WiNet bridge to establish a reservation for data transmission to the WiNet client in order to be able to receive data from the WiNet bridge. However, a WiNet bridge is not always capable of establishing an appropriate reservation for a requesting WiNet client.

### SUMMARY

There is now provided an enhanced solution for arranging reservation in wireless communications systems. This solution may be achieved by methods, apparatuses, and controller units, which are characterized by what is disclosed in the independent claims. Some embodiments of the invention are set forth in the dependent claims.

According to an embodiment of the invention, a first device is arranged to generate a reservation establishment request for requesting establishment or modification of unidirectional reservation by a second device for transmitting data to a first device, the reservation establishment request comprising an information element which can be used for defining reservation type. The reservation establishment request is transmitted to the second device. A reservation for data transmission associated with the first device is controlled on the basis of the information element.

The term ‘reservation’ is to be understood broadly to cover any kind of resource reservation for data transmission and/or reception. For instance, in one embodiment the reservation establishment request may be transmitted by a terminal device for initiating reservation of medium access slots of an ultra-wideband system, to enable reception of data from a bridge. The reservation type may be used to specify appropriate lower layer resources to establish a reservation to transmit data from the transmitting device generating the reservation to the receiving device (that has transmitted the reservation establishment request).

In one embodiment the information element comprises a value for the reservation type, whereby the second device may simply read the value of the information element. In an alternative embodiment the information element comprises information on the basis of which the actual reservation type value is derived.

In a further embodiment the reservation establishment request is a message of a protocol between the first device and the second device for data networking using media access control layer services.

Yet in one embodiment of the invention, the reservation establishment request is transmitted to a bridge device configured to establish or modify the reservation in a wireless ultra-wideband data transmission system to enable transmission of frames to the first device and to provide bridge services for the first device.

An improved access reservation solution is thus provided. Further features and advantages will become apparent from the following description and accompanying drawings.

### BRIEF DESCRIPTION OF THE DRAWINGS

In the following, the invention will be described in further detail by means of some embodiments and with reference to the accompanying drawings, in which

FIG. 1 is a block diagram illustrating networking scenarios for wireless communications;

FIG. 2 shows architectural reference model for data networking using WiNet services;

FIG. 3 is a flow diagram illustrating an embodiment of the invention;

FIG. 4 is a flow diagram illustrating an embodiment of the invention;

FIGS. 5a and 5b illustrate frame formats according to an embodiment of the invention; and

FIGS. 6a and 6b illustrate apparatuses according to an embodiment of the invention.

### DETAILED DESCRIPTION OF EMBODIMENTS

In the following embodiments references are made to entities and procedures specified for the WiMedia UWB system. However, embodiments of the present invention are not limited to any particular system, but the invention may be embodied for other wireless communication systems applying access reservation.

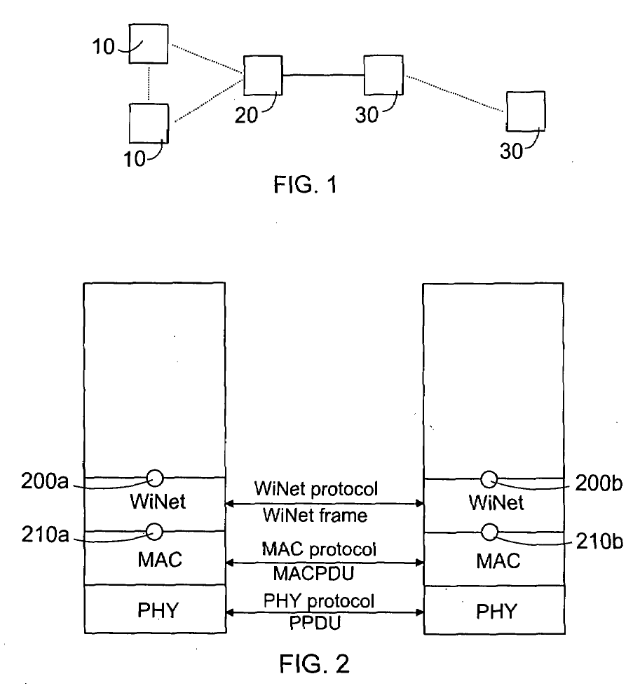

FIG. 1 illustrates exemplary networking scenarios for wireless communications. The example comprises devices with a client function (client devices) 10 and at least one device 20 with relay or bridge functionality (bridge device). The client devices 10 may communicate directly with other client devices that are neighbours. They may also communicate with other client devices 10 and nodes, such as Ethernet stations, by using the services of bridges 20.

There is a wide variety of devices, which may be arranged as communications devices by implementing the client device 10 functionality and/or the bridge 20 functionality, which will be described in more detail below. Some examples of such devices are cellular mobile stations, access point devices, PDA devices, mobile computers, desktop computers, printers, auxiliary devices, portable game devices, navigators, digital TVs, set top-boxes, media centers, or other domestic appliances. One application area of the UWB technology is to provide a wireless universal serial bus USB for wireless local connectivity between various devices.

In the WiNet embodiment the client devices 10 implement the WiNet protocol and are the original source or ultimate destination of data traffic conveyed in WiNet frames. The client devices 10 direct frames to a client bridge 20 in order to communicate with destination nodes reachable through the client bridge. Devices with a remote bridge function (remote bridges) 30 offer connectivity between network segments. Remote bridges 30 forward frames to and from other remote bridges 30, such that each pair of remote bridges creates a new segment bridged to the other segments attached to the remote bridges. Remote bridges make forwarding decisions by using a filter table.

A bridge 20, 30 provides IEEE 802.1D bridge functionality to allow forwarding of frames between client devices or remote bridges and other nodes on a network. The bridge 20, 30 advertises bridge capabilities in a WiNet Identification information element. A neighbour requests bridge services from the bridge 20, 30 in order to initiate the forwarding of frames between the neighbour and other nodes reachable through the bridge. A bridge 20 could offer connection to other client devices 10, to nodes reachable through wired or wireless ports using other protocols, or to both. A remote bridge 30 may request bridge services from another remote bridge, creating a pair that can link networks based on other protocols. A device (a client device 10 or a bridge 20, 30) may request bridge services from more than one bridge. Such a device might receive the same frame from multiple bridges. It is to be noted, despite the separation in FIG. 1, that a device may function both as a client bridge (20) and a remote bridge (30), and in the following a reference “bridge 20, 30” may refer to a device with client bridge and/or a remote bridge functionality.

FIG. 2 illustrates a platform based on WiMedia UWB and Winet. The physical (PHY) layer provides personal area network (PAN) wireless communications currently utilizing an unlicensed frequency (3 100-10 600 MHz in the US). In the current specification the UWB spectrum is divided into 14 bands, each with a bandwidth of 528 MHz. MultiBand Orthogonal Frequency Division Modulation (MB-OFDM) is used in WiMedia systems as the applied data modulation scheme. Frequency-domain spreading, time-domain spreading, and forward error correction (FEC) coding are used to vary the data rates.

The MAC layer provides MAC service by means of the MAC service access point (MAC SAP) 210a, 210b to one or more MAC service clients, in FIG. 2 the WiNet layer. The MAC sublayer relies on frame transmission and reception service provided by the physical layer via the PHY service access point (PHY SAP). Frame transmission and reception are supported by the exchange of parameters between the MAC sublayer and the PHY layer. The MAC sublayer is represented by a device address.

In the UWB MAC two channel access methods are defined: Distributed Reservation Protocol (DRP) and Prioritized Contention Access (PCA). The DRP enables devices to reserve one or more medium access slots (MAS) that the device can use to communicate with one or more neighbours. All devices that use the DRP for transmission or reception announce their reservations by including DRP information elements in their beacons. For more details on PHY and MAC layer functions, a reference is made to ECMA standard ECMA 368 “High Rate Ultra Wideband PHY and MAC standard”, 1^{st} edition, December 2005, hereby incorporated by reference.

The Winet protocol layer provides WiMedia medium access control MAC based networking service for a WiNet client, such as an IP layer, by means of the WiNet service access point (WiNet SAP) 200a, 200b. The MUX sublayer combined with the WiNet protocol corresponds to the logical link control sublayer of the standard ISO/OSI IEEE 802 reference model. In WiNet protocol layer WiNet frames are transferred between WiNet devices 10, 20, 30 (client to client, client to bridge, or bridge to bridge communications). WiNet uses a WiMedia-defined Protocol ID value to identify WiNet frames. WiNet defines four types of frames: standard data frames, abbreviated data frames, control frames, and association frames, identified by a frame type field. All WiNet devices 10, 20, 30 belong to one or more WiNet service sets (WSSs) in order to segregate traffic on the medium based on user-controlled membership in the WSSs. Before two devices can exchange standard or abbreviated data frames, the devices must be enrolled in and activate a common WSS and establish a connection using the WSS properties.

To initiate reservation establishment, or to modify an existing reservation, a client device 10 may send a DRP Establishment Request control frame to a WiNet peer entity of a bridge device 20. The bridge 20 either rejects the request, or accepts the request and reserves medium access slot(s) MAS(s) for transferring data to the client device 10. Previously the bridge 20 was not always capable of making good reservation for a requesting client device 10. The WiNet layer entity of the bridge 20 then transmits A DRP Establishment Response control frame to the client device informing of the outcome of the request.

In accordance with an embodiment, a reservation establishment procedure is arranged between networked devices such that a (client) device requesting reservation has a possibility to further affect the selection of reservation properties. In particular, the client device wishing to receive data, may request certain type of reservation for initiating a uni-directional reservation for transmitting data to the apparatus by a device receiving the request. It is to be noted that other reservation related information may be provided in addition or instead of the reservation type in the reservation establishment request.

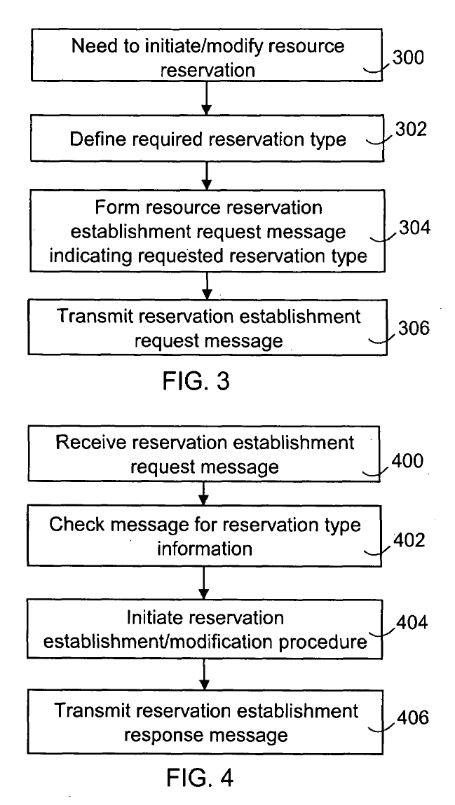

FIGS. 3 and 4 illustrate methods according to an embodiment. These features may be applied in connection with resource reservation by applying a modified WiNet protocol, but are not limited thereto.

FIG. 3 illustrates steps that may be carried out in a requesting communications apparatus requiring reservation for at least data reception, such as the client device 10. In step 300 there is a need to initiate a uni-directional reservation, or to modify an existing reservation for data transfer to the device applying the method. This step may be entered for various reasons for upper layer data reception. In accordance with the nature of the required transmission, there is a need for certain type of reservation. For generating a reservation establishment request, the reservation type for the requested reservation is defined in step 302. The reservation type may be defined on the basis of upper layer and/or lower layer requirements.

In step 304 a reservation establishment request, such as a distributed reservation protocol establishment request, is generated. The reservation establishment request comprises an information element for defining or indicating the reservation type. To enable definition of the reservation type by the receiving device, the reservation establishment request may be arranged to include the value for the reservation type, or some other information on the basis of which the reservation type may be derived. In step 306 the reservation establishment request is transmitted to a device capable of establishing the reservation, such as a WiNet bridge 20, 30.

FIG. 4 illustrates features of an entity receiving a reservation establishment request, such as the bridge 20, 30. In step 400 a reservation establishment request message is received from a requesting communications device (10). The message is checked in step 402 for reservation type information. The desired reservation type is defined on the basis of the information in the received reservation establishment request message. Additionally, at least some of the further information in the reservation establishment request message is checked.

On the basis of the reservation type and other relevant information it is defined if a reservation according to the reservation establishment request may be arranged (not specifically shown in FIG. 4). If appropriate, a reservation establishment procedure, which may be an initial procedure or an update, is initiated for the requesting device, as indicated in step 404. Thus, in the WiNet embodiment, the bridge 20, 30 may establish a DRP reservation in accordance with the reservation type detected in the received request. This step may be entered if the initial reservation or reservation modification for the apparatus is accepted (the checking procedure is not shown). After establishing the reservation, data transmission to the client device 10 may be arranged. If a reservation according to the requested reservation type cannot be arranged, the request is denied or a reservation according to another reservation type is established. A reservation establishment response is formed and transmitted 406 to the requesting device for indicating the result of the request.

The reservation type information may be stored in memory of the bridge 20, 30 in association with other reservation related data. It is to be noted that the FIGS. 3 and 4 illustrate only one embodiment, and that various modifications can be made.

In one embodiment DRP related procedures specified in the above identified WiMedia UWB ECMA standard ECMA 368 specification are applied in response to step 404 to establish or modify a DRP reservation. Hence, the bridge 20, 30 may initiate lower layer functions, i.e. MAC sub-layer DRP functions on the basis of the upper WiNet layer reservation establishment request message contents. For instance, the bridge 20, 30 may initiate WiMedia MAC layer specific DRP reservation negotiation by MAC layer command frames. The DRP reservation type in the MAC layer DRP reservation messages may be set in accordance with the content of the reservation type information element in the received WiNet layer reservation establishment request message.

In one embodiment the reservation establishment request is a WiNet protocol frame from the WiNet client device 10 to the WiNet bridge 20. The client device 10 may be configured to first register to bridge services before requesting establishment of reservation by the reservation establishment request including the reservation type. Steps illustrated in FIGS. 3 and 4 may thus be performed after the client device 10 has enrolled in and activated a WiNet service set (WSS) and established a connection with the bridge 20 by using the WSS properties.

As already indicated, in another embodiment the reservation establishment request is a WiNet protocol frame from a WiNet remote bridge 30 to another remote bridge 30. Similarly as the client 10, a remote bridge 30 may be the requesting device generating and transmitting the reservation establishment request with reservation type information element. Presently described and further embodiments may also be applied in such communications between remote bridges 30.

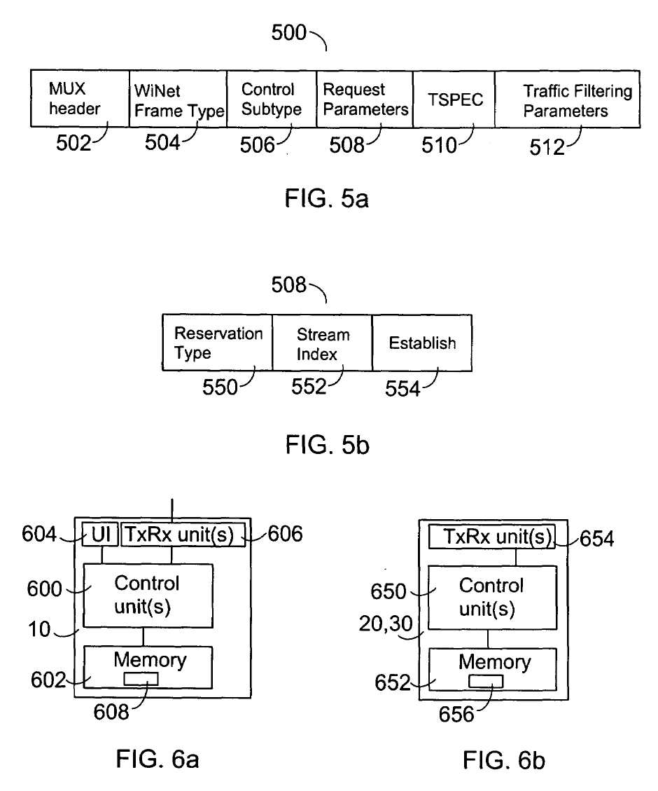

FIG. 5a illustrates in more detail a structure of a WiNet DRP establishment request frame 500 in which the reservation type may be encoded. Such frame is in one embodiment used to carry information on the reservation type to a bridge 20, 30 arranging reservation. The MUX header field 502 is a two-octet field including the WiNet protocol identifier. The value for control frames is “2” in the WiNet frame type field 504. The control sub-type field 506 specifies the type of the control frame, and indicates “2” for DRP establishment request. The Request Parameters field 508 specifies particulars of the reservation request. The traffic specification TSPEC field 510 includes data transfer related properties, such as service type, mean and peak data rate, maximum burst size, and data size. Field 512 includes traffic filtering parameters.

In one embodiment the reservation type is encoded in the Request Parameters field 508 of the WiNet DRP establishment request frame 500. FIG. 5b illustrates an example of such field 508. The field 508 includes information elements for Reservation Type 550, Stream Index 552, and Establish bit 554. The Establish bit 554 is set to one to indicate this is a request to establish or modify a reservation, or is set to zero to indicate this is a request to remove a reservation. The Stream Index field 552 is set to the value for the bridge 20, 30 to use in the DRP reservation Stream Index field. The Reservation Type field 550 is set to the value for the bridge 20, 30 to use in the DRP reservation Reservation Type field.

Table 1 illustrates reservation type encoding according to an embodiment. This encoding may be used in the reservation type field 550 of the WiNet DRP establishment request frame 500.

TABLE 1
Reservation Type field encoding

| Value | Reservation Type (4 bits) |
|---|---|
| 0 | Alien BP |
| 1 | Hard |
| 2 | Soft |
| 3 | Private |
| 4 | PCA |
| 5–7 | Reserved |

The reservation types are briefly described below. In case of hard DRP reservation only the owner of the DRP reservation can transmit data during the DRP reservation. The soft DRP reservation is similar to DRP reservation of type Prioritized Contention Access PCA, except the owner of the Soft DRP reservation can access the medium first. During the private DRP reservation, the channel is reserved only for the owner and the target(s). On Private DRP reservations, the owner and the target(s) are free to use any channel access mechanism they wish. During PCA DRP reservation, PCA specific channel access rules are used. Thus, all the devices can access the channel using a backoff-based contention mechanism, such as one specified in above-identified WiMedia MAC/PHY specification.

The client device 10 or the remote bridge 30 may be arranged (in step 302) to define one of the reservation types of the Table 1 in accordance with the upper layer requirements. An appropriate value for indicating this selected reservation type is then included in the WiNet DRP establishment request frame 500. Referring also to FIG. 4, the bridge 20, 30 checks (402) the value of the field 550. The bridge 20, 30 may then initiate (404) MAC layer reservation procedure accordingly.

As already illustrated, the client device 10 or the remote bridge 30 may thus be arranged to, besides (or instead) the higher protocol layer information (as illustrated by the TSPEC field), specify also lower layer requirements or properties, i.e. the MAC layer DRP reservation type, in the reservation establishment message. Correspondingly, the receiving bridge 20, 30 is arranged to check such lower layer information in the received reservation establishment message. This significantly enhances reservation establishment, since also lower layer information may be used for determining the properties of the reservation to be allocated. Thus, the requesting entity may request a specific type of reservation best suiting for the present reception event.

The frame formats of FIGS. 5a and 5b represent only one example of an applicable reservation establishment request. The implementation of the present features, some embodiments of which were illustrated above in connection with FIGS. 3 and 4, is not limited to any specific message format. For instance, further reservation types may be specified. The reservation type may also be indicated in other messages and message formats, such as in the reservation response message.

As illustrated in the simplified block diagram of FIG. 6a, a communications apparatus in general, and the communications device 10 apparatus illustrated in FIG. 1, comprises one or more units 606 for radio frequency (RF) communications (transmitter, receiver, transceiver) enabling the communication in accordance with the radio access technology or technologies supported by the device. The device 10 also includes a user interface 604 for user input/output. The operation of the device 10 and various elements thereof is controlled by one or more control units 600 (such as a micro controller, micro-processor, or any other programmable device) having an associated memory 602 for storing data and software.

FIG. 6b illustrates basic elements of a communications device such as the bridge 20, 30. Such apparatus comprises one or more control units 650, memory 652, and communications unit(s) 654. It is to be noted that FIGS. 6a and 6b are simplified to illustrate the basic elements of the devices between which a reservation establishment procedure is arranged, and detailed description of a UWB transmitter/receiver components for implementing the MAC and PHY layers is omitted.

Computer program code portions 608, 656 stored in the memories 602, 652 and executed in the processing unit 600, 650 may be used for causing the device 10 and the bridge 20, 30, respectively, to implement a method and means for providing the inventive functions relating to reservation establishment procedure, some embodiments of the inventive functions were illustrated above in association with FIGS. 1 to 5.

A control entity may be provided in the requesting device 10, 30 to control reservation establishment request procedure and to include the reservation type information in reservation establishment requests to the bridge 20, 30. Also the bridge 20, 30 is provided by one or more control entities implementing at least some of the above-illustrated features related to received reservation establishment requests in the bridge 20, 30. Such control entity may be provided in the devices 10, 20, 30 by a WiNet protocol entity, a control entity for WiNet protocol layer entity, or an upper layer control entity, for instance.

Referring also to FIG. 2, in one embodiment the WiNet protocol entity in the requesting client device 10 or remote bridge 30 is arranged to specify (in steps 302 and 304) the reservation establishment request specifying the reservation type on the basis of information received from an upper layer and/or a lower layer entity. The WiNet entity may then provide the reservation establishment request to the MAC SAP for transmission by the MAC layer service and entity. On the basis of a reservation establishment request received from the MAC layer, a WiNet entity in the bridge device 20, 30 may implement at least part of the steps of FIG. 4. The WiNet entity may thus instruct the MAC layer to start MAC layer reservation establishment in accordance with the reservation type detected in the reservation establishment request.

Hence, by interaction of logical entities in the device 10 and in the bridge 20, 30 it is possible to implement above illustrated features. These entities may be implemented by execution of a stored program code 608 in a processing unit 600 in the device 10, and by a stored program code 656 in a processing unit 600 in the bridge 20, 30, for instance.

Another embodiment of the present invention is a silicon chip unit or a module for controlling the device 10 and/or the bridge 20, 30. The unit may be configured to cause the device to perform the inventive functions. Such unit comprises an interface for connecting to further communications means of the device mechanically and/or functionally. One example of such unit is a sub-assembly. For instance, the unit may be provided by an integrated single chip solution, or as a removable, supplementary unit to an electronic device. The unit may be a controller unit for controlling wireless communications, or a communications unit providing above illustrated features related to arranging use of reservation messages. In one embodiment the unit is an ultra wideband media access controller. Besides above illustrated WiNet protocol layer functions, the unit may provide at least some further features, such as the MAC and PHY layer functions of the WiMedia specification.

The accompanying drawings and the description pertaining to them are only intended to illustrate the present invention. Different variations and modifications to the invention will be apparent to those skilled in the art, without departing from the scope of the invention defined in the appended claims. Different features may thus be omitted, modified or replaced by equivalent one. For instance, the application of the current invention is not limited to the currently defined combinations of the dependent and independent claims, but the dependent claims may refer to any preceding independent and dependent claim in the same category.

1. An apparatus for wireless communications, comprising:
a controller configured to generate a reservation establishment request for requesting establishment or modification of unidirectional reservation by a wireless communication device for transmitting data to the apparatus, the reservation establishment request comprising an information element for defining reservation type, and
a transmitter portion for transmitting the reservation establishment request to the wireless communication device.

2. An apparatus according to claim 1, wherein the information element comprises a value for the reservation type.

3. An apparatus according to claim 1, wherein the apparatus is configured to transmit the reservation establishment request to a bridge device configured to establish or modify the reservation to enable transmission of frames to the apparatus and to provide bridge services for the apparatus.

4. An apparatus according to claim 1, wherein the apparatus is configured to generate the reservation establishment request for triggering data transmission access resource reservation by the wireless communication device in a wireless ultra-wideband data transmission system.

5. An apparatus according to claim 1, wherein the apparatus is configured to function as a WiNet client or a WiNet remote bridge and the reservation establishment request is a control frame of a WiNet networking protocol, and
the apparatus is configured to transmit the reservation establishment request of the WiNet protocol layer to a WiNet bridge for triggering media access control layer reservation procedure by the WiNet bridge.

6. An apparatus according to claim 5, wherein the reservation establishment request is a distributed reservation protocol establishment request frame, and the apparatus is configured to specify the reservation type in a request parameters field of the distributed reservation protocol establishment request frame.

7. An apparatus for wireless communications, comprising:
a receiver portion for receiving from a wireless communications device a reservation establishment request for requesting establishment or modification of unidirectional reservation for transmitting data to the wireless communications device, the reservation establishment request comprising an information element for defining reservation type, and
a controller for controlling reservation for data transmission associated with the wireless communications device on the basis of the reservation type indicated by the information element.

8. An apparatus according to claim 7, wherein the apparatus is a bridge device configured to establish or modify the reservation in a wireless ultra-wideband data transmission system to enable transmission of frames to the communications device and provide bridge services for the communications device.

9. An apparatus according to claim 7, wherein the information element comprises a value for the reservation type.

10. An apparatus according to claim 7, wherein the apparatus is configured to function as a WiNet client bridge and/or a remote bridge,
the apparatus is configured to receive the reservation establishment request as a control frame of a WiNet networking protocol from a WiNet client or a WiNet remote bridge, and
the apparatus is configured to trigger media access control layer reservation procedure on the basis of the reservation establishment request of the WiNet protocol layer.

11. An apparatus according to claim 10, wherein the reservation establishment request message is a distributed reservation protocol establishment request frame, and the apparatus is configured the check the reservation type in a request parameters field of the distributed reservation protocol establishment request frame.

12. A method for triggering access reservation between wireless devices, the method comprising:
generating a reservation establishment request for requesting establishment or modification of unidirectional reservation by a second device for transmitting data to a first device, the reservation establishment request comprising an information element for defining reservation type, and
transmitting the reservation establishment request to the second device.

13. A method according to claim 12, wherein the reservation establishment request is transmitted to a bridge device configured to establish or modify the reservation in a wireless ultra-wideband data transmission system to enable transmission of frames to the first device and to provide bridge services for the first device.

14. A method according to claim 12, wherein first device is configured to function as a WiNet client or a WiNet remote bridge and the reservation establishment request is a control frame of a WiNet networking protocol, and
the first device is configured to transmit the reservation establishment request of the WiNet protocol layer to a WiNet bridge for triggering media access control layer reservation procedure by the WiNet bridge.

15. A controller unit for a communications device, wherein the controller unit is configured to generate a reservation establishment request for requesting establishment or modification of unidirectional reservation by a second device for transmitting data to the communications device, the reservation establishment request comprising an information element for defining reservation type,
provide the reservation establishment request for transmission to the second communications device.

16. A controller unit as claimed in claim 15, wherein the controller unit is an ultra wideband media access controller.

17. A controller unit for a communications device, wherein the controller unit is configured to check a reservation establishment request received from a wireless communications device for requesting establishment or modification of unidirectional reservation for transmitting data to the wireless communications device, the reservation establishment request comprising an information element for defining reservation type, and
the controller unit is configured to control reservation for data transmission associated with the wireless communications device on the basis of the reservation type indicated by the information element.

18. A controller unit as claimed in claim 17, wherein the controller unit is an ultra wideband media access controller configured to function as a bridge device.

19. A method for triggering access reservation between a client and a client bridge or between a first remote bridge and a second remote bridge, comprising:
transmitting a distributed resource protocol reservation establishment request of a logical link control layer networking protocol from a client to a client bridge or from a first remote bridge to a second remote bridge for requesting establishment or modification of a distributed resource protocol reservation for transmitting data to the client or the second remote bridge, the distributed resource protocol reservation establishment request comprising a field for reservation type.
